(19) United States
(12) Patent Application Publication
(10) Pub. No.: US 2023/0017716 A1
(43) Pub. Date: Jan. 19, 2023

(54) Lid used in a device for making kefir using kefir grains

(71) Applicant: Andrey Danilin, Lakewood, CO (US)

(72) Inventor: Andrey Danilin, Lakewood, CO (US)

(21) Appl. No.: 17/850,941

(22) Filed: Jun. 27, 2022

(30) Foreign Application Priority Data
Jul. 1, 2021 (RU) 2021119373

(51) Int. Cl. A23C 9/12; A23C 9/127

(52) U.S. Cl. CPC A23C 9/1223; A23C 9/127

(57) ABSTRACT

A lid that is used in household devices for preparing kefir using kefir grains. The lid comprises a rotating means located in the lid, a stirring rod connected to the rotating means, a container with holes for placing grains for fermentation within it and equipped with a cap and mounted on the stirring rod, and a control unit connected to the rotating means. The lid assembly is characterized in that the container with holes is affixed on the stirring rod in such a way that the axis of symmetry of the container is not aligned with the vertical axis of rotation of the stirring rod.

### CROSS REFERENCE TO RELATED APPLICATIONS

The present application claims priority benefits from the foreign patent application filed on Jul. 1, 2021, in Russia Application No. 2021119373 with the title A Device for Making-Fermented Dairy Product [symbol] [symbol] [symbol] [symbol] , and naming Andrey Danilin as an inventor. The foregoing application is hereby incorporated herein by reference in its entirety.

### BACKGROUND OF THE INVENTION

The claimed utility patent relates to household devices for preparing kefir at home using kefir grains for fermentation.

Fermented dairy products are essential for the human body. The distinctive feature of fermented dairy products is their high nutritional value, as well as the presence of a number of beneficial medicinal properties.

Over many years of use, fermented dairy products have practically proven their health-improving effects on the human body, so the demand for these products in nutrition is quite understandable. Of the wide variety of fermented dairy drinks on the market, kefir is one of the most ancient products. It is prepared by a complex fermentation process using kefir grains for fermentation, which are a natural symbiosis of bacteria.

Kefir has a unique and complex composition of microbial species which sharply distinguishes it from all other fermented dairy drinks. Researchers have identified more than 50 healthy bacteria in the kefir grains. Kefir is beneficial for the gastrointestinal tract, as it contains beneficial microorganisms that have a positive effect on digestion. Kefir “rejuvenates” the body, cleanses the blood, and normalizes the acid balance and microflora of the gastrointestinal tract. For people with lactose intolerance, drinking kefir either eliminates or drastically reduces symptoms. According to scientific studies, it was found that kefir has a positive effect on the nervous system, providing a soft relaxation effect. Studies have shown that the consumption of probiotics, which are found in large quantities in kefir, helps with diarrhea, as well as with digestive disorders caused by antibiotics, and helps to restore the intestinal microflora after a course of antibiotics. Probiotics, that are contained in kefir, not only increase the body's defenses, but also reduce the level of production of carcinogens. This effect prevents the development of malignant tumors.

### BACKGROUND ART

There is a portable device for fermenting milk into kefir from at least one kefir grain agglomerate, the device comprising:

a container having an upper opening, the container defining a reaction space therein for containing milk;

a lid removably attachable to the upper opening of the container to enclose the reaction space, the lid including a plurality of holes for the passage of air into and out of the reaction space;

a separate vessel defining an internal space configured for containing at least one kefir grain agglomerate, the vessel dimensioned for being wholly insertable into the reaction space of the container;

the separate vessel including a plurality of ports formed therein for providing the flow of milk in the reaction space into and out of the vessel internal space to contact at least one kefir grain agglomerate therein for fermentation to form kefir; and

an elongated tube adapted to project through an opening in the lid and into the reaction space of the container, the tube configured for allowing the drinking of kefir fermented from milk from the reaction space of the container;

the elongated tube engaging the separate vessel and passing therethrough isolated from the internal space for supporting and suspending the vessel in the reaction space of the container for fermentation while allowing drinking of kefir from outside of the vessel internal space. (U.S. Pat. No. 10,327,451 B2, priority Oct. 15, 2014, publ. applications Apr. 21, 2016, patent publication Jun. 25, 2019, IPC C12M 1/00, C12M 3/00, A23C 9/12 (2006 January ).

In the known device, due to the lack of mixing, there will be no interaction of kefir grains with fresh milk, which is very important for the uniform distribution of microorganisms in milk during fermentation, and, as a result, the device will not allow the preparation of kefir of high organoleptic quality and cannot guarantee the production of a functionally active product.

In addition, if the grains, after the kefir is ready, are left in the finished product, overfermentation will occur, which will lead to a significant decrease in taste and the product would not be satisfactory for consumption.

There is an apparatus for production of kefir in the household; the device consists of an outer vessel and an inner vessel which enters the outer vessel, and the stirring paddle is located on the axis of an electric motor, wherein:

a) the electric motor is connected with a time relay that automatically turns the electric motor on and off several times a day;

b) the electric motor is arranged on a perforated lid,

c) the electric motor axis with the stirring paddle rotates with the speed range of 10-30 rpm,

d) the stirring paddle has holes with a diameter of 3-5 mm, and

e) the inner vessel has holes with a diameter of 3-5 mm.

The apparatus according to the patent is also characterized in that a sound signal and/or a light signal is attached, which reports 24 hours after turning on the device that the production of kefir is completed.

(German patent DE 10 2012 023 476 B3, prior. Nov. 27, 2012, publ. Sep. 19, 2013, IPC A47J 43/044, A47J 43/07, A47J43/08 (2013 January).

In the known device, to remove grains from the kefir after the end of preparation, the product must be strained, which is troublesome and inconvenient for users.

A known biofermenter for the production of kefir, comprising a container for receiving milk and a cage for receiving kefir pollen, which can be submerged in a container, the cage has a bottom for storing the kefir grains, a rim for laterally restraining the kefir grains and a lid for enclosing the kefir grains in the cage. (German application DE 10 2017 110 617 A1, priority May 16, 2017, published Nov. 22, 2018, IPC A23C A23C 9/127, C12M 1/02, A01J 25/00 (2006 January)

In the aforementioned application, the placement of kefir grains is proposed in a cage with special rims that do not allow grains to come into contact with each other. To carry out such a layout of the grains will be extremely troublesome and inconvenient and can lead to physical damage to the grains and to the loss of bacteria in the outer layer of the grains. Due to the fact that the composition of kefir grains is heterogeneous, the loss of the outer layer of bacteria is highly undesirable, since this will lead to a disruption in the process of fermentation of milk by kefir grains and, as a result, the organoleptic characteristics of kefir will not be satisfactory. In addition, the grains are constantly growing, and, because of this, it will be necessary to constantly rearrange the layout of the grains, that is, constantly physically injure the grains, which, as mentioned earlier, is highly undesirable.

There is a device for the preparation of fermented milk products (utility model RU 169562, class A23C 9/12 , A47J 31/00) comprising a main body, including an outer shell and an inner wall, where the inner wall forms a cavity with an upper opening, a removable reservoir partially or completely inserted into the cavity, an inner lid for the removable reservoir, and a main lid for the main body. An inner vessel is formed between the outer shell and the inner wall, containing a heating device with side heating means, which contain at least one side heating wire wound in a spiral form with multiple turns around the inner wall. The inner wall forms grooves to accommodate the side heating wire. In addition, the device contains a control unit with a control panel for selecting the heating mode.

This known device does not provide for mixing of the fermented product to ensure that the grains have sufficient contact with fresh milk, which is one of the important conditions when fermenting milk with kefir grains, and using this device, it is impossible to obtain kefir with good taste. In addition, after the completion of the preparation of a fermented milk product in the known device, the product must be strained to remove the grains used for fermentation, which is troublesome and inconvenient for users.

There is a stirring type yoghurt machine which comprises a shell, a heating device which is arranged at the bottom of the shell, an inner container which is arranged inside the shell and props against the heating device, and a cover which is arranged at the top part of the shell, wherein a drive motor is arranged inside the cover; a control switch which is connected with the drive motor is arranged at the top part of the cover; the drive motor is connected to a stirring rod which stretches into the inner container; and a condiment box is connected to one end of the stirring rod which stretches into the inner container. Due to the drive motor arranged inside the cover, the stirring rod connected to the drive motor and the condiment box arranged on the stirring rod, the cover does not need to be opened to stir or condition the yoghurt, and at the same time the yoghurt and the condiment are uniformly mixed, and the taste of the yoghurt is ensured. (China patent for utility model CN 203028030 U (CN 201320039239), prior Jan. 18, 2013, published 07/03/2013, IPC A23C 9/12).

If this device were to be used for kefir fermentation by placing kefir grains into the condiment box, the design of the aforementioned device would not allow uniform and complete fermentation of milk due to insufficient amount of fresh milk washing over the grains, which leads to a non-uniform distribution of microorganisms in milk that affect the organoleptic properties of the final product.

Specifically, the location of the condiment box with kefir grains on the same axis as the stirring rod offers very little possibility for fresh milk particles located far from the axis of rotation of the stirring rod to contact the kefir grains within the condiment box, and therefore the fermentation will occur only inside or directly adjacent to the condiment box.

Also, the design of the known device does not allow uniform and complete fermentation of milk due to insufficient mixing. Poor mixing does not provide the necessary conditions for optimal interaction of kefir grains with milk and the development of microorganisms that affect the organoleptic properties of the final product.

### SUMMARY OF THE INVENTION

The problem solved by the invention is the development of an easy-to-maintain device that provides optimal conditions for the performance of kefir grains and for keeping grains active during the process of making kefir.

The result of the invention is increased kefir quality through improving the organoleptic characteristics and improvement of functional activity of the prepared fermented product.

The posed problem is solved and the indicated result is achieved by the fact that the invented lid used in the device for preparing kefir using kefir grains comprises:

a rotating means, for example a drive motor, located in the lid, a stirring rod connected to the rotating means, a container with holes for placing grains for fermentation within it and equipped with a cap and mounted on the stirring rod, a control unit connected to the rotating means, and is characterized in that the container with holes is affixed on the stirring rod in such a way that the axis of symmetry of the container is not aligned with the vertical axis of rotation of the stirring rod.

Affixing the container with holes on the stirring rod out of alignment with the vertical axis of rotation of the stirring rod ensures that grains are located in the path of the milk flow, increasing the force of the milk flow passing through the container holes and promoting the occurrence of turbulence inside the container. Between adjacent layers of milk there is an exchange of particles, causing mixing of the boundary layers, and increasing the interaction of kefir grains with milk inside the container. In addition, this arrangement of the container also creates opportunity for the fresh milk particles located far from the axis of rotation of the stirring rod to interact with kefir grains located inside the container. As a result, the efficiency of the milk fermentation process is increased, and the organoleptic characteristics of the fermented product are enhanced. In addition, when affixing the container with holes on the stirring rod out of alignment with the vertical axis of rotation of the stirring rod, the mixing efficiency is enhanced. Efficient mixing of the fermentation mixture inside the vessel in which kefir is prepared prevents the development of mold on the surface of the fermented product and contributes to the uniform distribution of microorganisms.

In one embodiment, the container for grains is affixed at an angle of 30 to 90 degrees to the vertical axis of rotation of the stirring rod. This approach creates the strongest flow of milk passing through the openings of the container and increases the turbulence inside the container, intensifying the interaction of kefir grains with milk inside the container.

In another embodiment, the stirring rod is removable. Making the stirring rod removable simplifies the sanitization of the rod after each use of the device.

The stirring rod can be made with a bend. Making the rod with a bend allows increasing the size of the container, making it larger (longer) than the radius of the selected fermentation vessel and allows the container with holes to rotate freely inside the selected fermentation vessel without touching the walls of the vessel. The larger size of the container ensures ample space for the grains in the container and, as a result, the milk is better able to wash over the grains in the container which enhances the fermentation process of the milk. In addition, the bend of the stirring rod contributes to better mixing of milk and an even distribution of microorganisms during the preparation of the product.

In another embodiment, the claimed device is characterized by the fact that the container with holes is removable. Making the container with holes removable will simplify the use of the device, because after the end of the preparation of the product, the container can be easily removed, and sanitizing the container and working with the grains becomes easier.

The container with holes is equipped with a cap. Equipping the container with a cap prevents the fermentation grains from falling out of the container when it is mounted on stirring rod at an angle to the vertical axis of rotation of the stirring rod.

In another embodiment, the claimed device is characterized by the fact that the attachment of the container for grains to the stirring rod can be made by means of spring arms made to grasp the container and press closed the cap of the container.

In another embodiment, the claimed device is characterized by the fact that the holes are located over the entire surface of the container. Making holes over the entire surface will improve the penetration of milk into the container and, thereby, enhance the interaction of grains with milk.

In another embodiment, the proposed device is characterized by the fact that a paddle can be affixed on the stirring rod, made in the form of a toothed partition, containing at least 4 teeth and with a distance between them of at least 5 mm. This improvement will increase the turbulence of the milk in the layers outside the zone of container rotation.

In another embodiment, the claimed device is characterized by the fact that the drive motor can be made with the possibility of rotation of the stirring rod and with the possibility of its reciprocating movement in the vertical direction. The implementation of the drive motor with the possibility of rotation of the stirring rod and with the possibility of its reciprocating movement in the vertical direction (up and down) will increase the turbulence of milk flow inside the vessel in which kefir is prepared and improve conditions to ensure uniform distribution of microorganisms and enhance the mixing effect inside the container with holes to increase the efficiency of the interaction of milk with grains.

In addition, the claimed device is characterized by the fact that the panel of the control unit can be located on the top side of the lid. This solution is technically the most optimal.

### BRIEF DESCRIPTION OF DRAWINGS

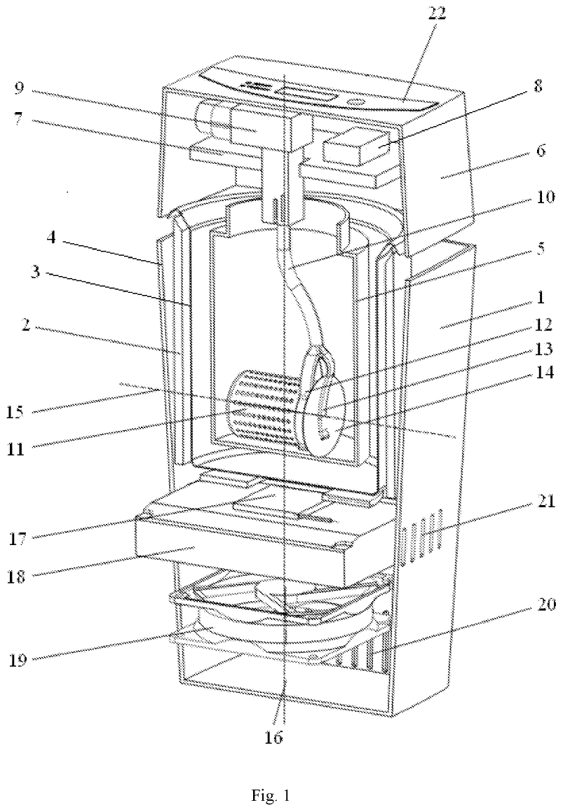

The invented lid that provides optimal conditions for the performance of kefir grains and for keeping grains active during the process of making kefir is illustrated in the drawing (FIG. 1), which shows in section a device for making kefir, to which the invented lid is applied.

The device for making kefir includes:

housing 1 with a heat-insulating gasket 2 located between the inner wall 3, made of material with high thermal conductivity, and the outer wall 4 of the housing 1. Inside the housing 1 there is a vessel 5 for milk to be fermented into kefir, made mainly of glass. A lid 6 with a heat-insulating gasket 7 is located on top of the housing 1. Inside the lid 6, are mounted a control unit 8 and an associated rotating means 9, for example a drive motor, which provides the rotation of the stirring rod 10. The rotating means 9 is configured to rotate the stirring rod 10, and, moreover, it is possible to reciprocate the rod in the vertical direction (up and down). At the end of the stirring rod 10, made with a bend, a container with holes 11 is attached for the placement of kefir grains for fermentation, and made of a material resistant to acids.

The container with holes 11 is attached by fixing elements in the form of spring arms 12, made to grasp the container with holes 11, and a spring end arm 13 for pressing closed the lid 14 of the container with holes 11. The container with holes 11 is affixed to the stirring rod 10 in such a way that the axis of symmetry 15 of the container with holes 11 does not align with the vertical axis of rotation 16 of the stirring rod 10 (preferably at an angle of 90°).

The length of the container with holes 11 is selectively chosen to ensure ample space for the grains for fermentation in the container, leaving sufficient space for the milk to penetrate into the container and wash over the grains.

To establish the fermentation temperature, a heater/cooler 17 may be installed in the lower part of the housing 1, made, for example, utilizing a Peltier element. An accompanying heat exchanger 18, made, for example, of aluminum, is mounted under the heater/cooler 17. An accompanying fan 19 may be mounted under the heat exchanger 18. For the fan 19, openings for the air intake 20 and openings for air exhaust 21 are made in the lower part of the housing 1.

To regulate the process of making kefir, a control panel 22 is located on the lid 6 and connected to the control unit 8.

### DETAILED DESCRIPTION OF THE INVENTION

The device for making kefir with the invented lid that provides optimal conditions for the performance of kefir grains works as follows:

Milk is poured into a glass vessel 5, the volume of which is, for example, 1000 ml. The vessel 5 is installed inside the housing 1. Grains for fermentation in the amount of 10-20 grams per 1000 ml of milk are placed in the container with holes 11, and the container 11 is closed with a cap 14. The container with holes 11 is affixed to the stirring rod 10, for example, with the help of spring arms 12, and with the help, for example, of a spring end arm 13, the cap 14 of the container with holes 11 is pressed closed. The stirring rod 10 with attached container with holes 11 is connected to the rotating means 9, for example, a drive motor. In this assembly, the axis of symmetry 15 of the container with holes 11 is located out of alignment with the vertical axis of rotation 16 of the stirring rod 10. The housing 1 is closed with a lid 6 with a built-in rotating means 9, for example, a drive motor, to which the stirring rod 10 with a container with holes 11 is attached. Thus, the container with holes 11 is immersed in the vessel 5. After that, on the control panel 22 the kefir preparation mode is selected. If a heater/cooler 17 is used, for example, utilizing a Peltier element, then, with the help of the heat exchanger 18, and the fan 19, the necessary temperature conditions may be maintained for the optimal performance of kefir grains. In turn, the stirring rod 10 with the container with holes 11 at the end begins to rotate and reciprocate with the help of the rotating means, for example a drive motor. Due to the location of the container with holes 11 at an angle to the vertical axis of rotation 16 of the stirring rod 10, the turbulence of milk flow inside the vessel 5 is increased and ensures that sufficient fresh milk washes over the grains inside of the container with the holes 11. The bend of the stirring rod 10 allows the use of container with holes 11 of a larger size, reaching a length of up to 0.9 of the diameter of the vessel 5. Thus, there is sufficient space between the grains inside the container with holes 11 to ensure the best contact of kefir grains with fresh milk during the fermentation of milk.

The duration of the preparation of kefir is approximately 24 hours. At the end of preparation, the control unit 8 sends a signal to the user on the control panel 22. To remove the kefir, the lid 6 is lifted, and the stirring rod 10 with the container with holes 11 is removed from the vessel 5. The container with holes 11 containing kefir grains for fermentation is disconnected from the stirring rod 10 by flexing spring arms 12 and 13. The fermentation grains are then placed in milk for storage until the next use. Kefir in vessel 5 is ready for consumption.

### Conclusions and Ramifications

The inventive lid used in the device for making kefir is not limited to the described embodiment and can be modified in other embodiments which does not constitute departure from the true spirit and scope of this invention. For example, the container with holes for grains can have a different shape, or communication with the control unit can be carried out remotely, without installing the control unit panel anywhere on the device, for example, through a program installed on a mobile phone.

At present, a prototype device with the inventive lid has been developed. Tests of the device showed successful results in the preparation of high-quality kefir.

Having thus described the invention, what is desired to be protected by Letters Patent is presented in the subsequently appended claims:

1. A lid that is used in a device for making kefir using kefir grains comprising:
a) a rotating means located in the lid,
b) a stirring rod connected to the rotating means,
c) a container with holes for placing grains for fermentation within it and equipped with a cap and mounted on the stirring rod,
d) a control unit connected to the rotating means,
wherein the container with holes is affixed on the stirring rod in such a manner that the axis of symmetry of the container does not align with the vertical axis of rotation of the stirring rod,
whereby the easy-to-maintain lid provides optimal conditions for the performance of kefir grains and for keeping grains active during the process of fermentation to enable the preparation of high-quality kefir with improved organoleptic characteristics and functional activity.

2. The lid according to claim 1, wherein the axis of symmetry of the container with holes is affixed at an angle of 30 to 90 degrees to the vertical axis of rotation of the stirring rod,
whereby the angled position of the container creates the strongest flow of milk passing through the openings of the container and increases the turbulence of the milk, intensifying the interaction of kefir grains with milk inside the container.

3. The lid according to claim 1, wherein the stirring rod is removable,
whereby sanitization of the rod after each use of the device is simplified.

4. The lid according to claim 1, wherein the stirring rod is made with a bend, whereby the size of the container can be increased to make it larger (longer) than
the radius of the selected fermentation vessel which ensures ample space for the grains in the container and, as a result, the milk is better able to wash over the grains in the container which enhances the fermentation process of the milk; furthermore, the bend of the stirring rod contributes to better mixing of milk and an even distribution of microorganisms during fermentation.

5. The lid according to claim 1, wherein the container with holes is removable,
whereby the container can be easily removed after the end of the preparation of the product for sanitization and working with the grains becomes easier.

6. The lid according to claim 5, wherein at the end of the stirring rod there is a fixing element in the form of spring arms made to grasp the container with holes and press closed the container cap,
whereby the container may be easily and simply connected to and separated from the rod.

7. The lid according to claim 1, wherein the holes are located over the entire surface of the container,
whereby penetration of milk into the inside of the container is increased and, thereby, enhances the interaction of grains with milk.

8. The lid according to claim 1, wherein a paddle is fixed on the stirring rod, made in the form of a toothed partition, containing at least 4 teeth and with a distance between them of at least 5 mm,
whereby the turbulence of the milk in the layers outside of the zone of container rotation is increased, which improves the efficiency of fermentation and the organoleptic properties of the final product.

9. The lid according to claim 1, wherein the means of rotation is a drive motor,
Whereby the fermentation process can be preprogramed for an automatic rotation at a given time for a given duration.

10. The lid according to claim 9, wherein the drive motor is made with the possibility of rotation of the stirring rod and with the possibility of its reciprocating movement in the vertical direction, whereby the turbulence of milk flow inside the vessel in which kefir is prepared is increased and improves the conditions to ensure uniform distribution of microorganisms and enhances the mixing effect inside the container with holes to increase the efficiency of the interaction of milk with grains.

11. The lid according to claim 1, wherein the control unit panel is located on the top side of the lid,
whereby the user is able to easily and conveniently operate the lid and view status and settings.

12. The lid according to claim 1, wherein the axis of symmetry of the container with holes varies dynamically throughout the fermentation process,
whereby the varied position of the container creates the strongest and most chaotic flow of milk passing through the openings of the container and increases the turbulence inside and outside of the container, intensifying the interaction of kefir grains with milk inside the container to improve overall kefir quality.
